(19) United States
(12) Patent Application Publication
(10) Pub. No.: US 2016/0182625 A1
(43) Pub. Date: Jun. 23, 2016

(54) SYSTEMS AND METHODS FOR ESTABLISHING AD-HOC NETWORKS

(71) Applicants: Solomon Trainin, Haifa (IL); Assaf Kasher, Haifa (IL)

(72) Inventors: Solomon Trainin, Haifa (IL); Assaf Kasher, Haifa (IL)

(21) Appl. No.: 14/573,687

(22) Filed: Dec. 17, 2014

(51) Int. Cl. H04L 29/08; H04W 84/20

(52) U.S. Cl. CPC H04L 67/1051; H04W 84/20

(57) ABSTRACT

Systems and methods to provide ad-hoc networks by establishing peer-to-peer communicative connections where one user device is deemed a group owner user device and the other user device(s) are deemed client user device(s) is disclosed. The group owner may be determined, based at least in part on a rank score indicative of a device type of the user devices that are to form a peer-to-peer communicative connection. Furthermore, secondary parameters, such as remaining battery life for each of the user devices that are to form a communicative connection may be used to identify the group owner.

### TECHNICAL FIELD

This disclosure generally relates to systems and methods for establishing ad-hoc networks.

### BACKGROUND

User device, such as mobile communications devices, may be configured to interface with a network. In some cases, this network may include access points (e.g., wireless routers, Internet, etc.) to which one or more user devices may connect. In other cases, the user devices may establish communicative peer-to-peer links directly among themselves to form an ad-hoc network. In some cases, when establishing an ad-hoc network, a group owner may be established. The group owner may facilitate the addition of other nodes (e.g., user devices or end devices) to the ad-hoc network.

### BRIEF DESCRIPTION OF THE FIGURES

Reference will now be made to the accompanying drawings, which are not necessarily drawn to scale, and wherein:

FIG. 1 is a simplified schematic diagram of an example environment having a plurality of user devices configured to communicate with one or more other user devices and/or end devices, in accordance with example embodiments of the disclosure.

FIG. 2 is a simplified block diagram illustrating an example user device for forming a peer-to-peer network, in accordance with example embodiments of the disclosure.

FIG. 3 is a flow diagram illustrating an example method for determining a group owner among two devices that are to establish an ad-hoc network, in accordance with certain example embodiments of the disclosure.

FIG. 4 is a flow diagram illustrating an example method for determining a group owner of an ad-hoc network based at least in part on a rank score of each of the user devices along with one or more other parameters associated with each of the user devices, in accordance with certain example embodiments of the disclosure.

FIG. 5 is a flow diagram illustrating an example method for determining a group owner of an ad-hoc network based at least in part on an intent level of two devices that are to form the ad-hoc network, in accordance with certain example embodiments of the disclosure.

### DETAILED DESCRIPTION OF EMBODIMENTS OF THE INVENTION

Embodiments of the disclosure are described more fully hereinafter with reference to the accompanying drawings, in which example embodiments of the disclosure are shown. This disclosure may, however, be embodied in many different forms and should not be construed as limited to the example embodiments set forth herein; rather, these embodiments are provided so that this disclosure will be thorough and complete, and will fully convey the scope of the invention to those skilled in the art. Like numbers refer to like, but not necessarily the same or identical, elements throughout.

Example embodiments of the disclosure may provide systems, apparatus, processes, and methods for establishing peer-to-peer or ad-hoc networks between two or more user devices, such as wireless communications devices. When establishing the peer-to-peer connection between two user devices, there may be a process of discovery, where the two user devices broadcast respective beacons and/or probe frames indicating their presence and information about itself. This announcement and discovery phase may be performed in accordance to any number of known or future protocols established for the purposes of forming peer-to-peer, mesh and/or ad-hoc networks, such as Wi-Fi Peer-to-Peer (P2P) Technical Specification, WiFi Direct, Bluetooth, ZigBee, or the like. After the announcement and/or discovery phase, the user devices may engage in a negotiation process to determine the group owner (GO) from among the two user devices attempting to establish the ad-hoc network. The GO user device may be a point of communicative connection for subsequent devices that may be added to the ad-hoc group or network.

In example embodiments of the disclosure, a user device that is in the GO negotiation process may exchange one or more messages with another device with which an ad-hoc network is to be established. This may entail a message(s) such as GO negotiation request(s), GO negotiation response(s), and/or GO negotiation confirmation. Each of these GO negotiation messages may be utilized to communicate one or more parameters between the two user devices that are to establish the ad-hoc network.

In example embodiments, to determine which of two user devices (e.g., mobile communications devices or end devices) are to be a GO device and which is to be a client device, the devices may use a rank associated with device type of each of the user devices. The device type is exchanged between communicating devices as part of the GO negotiation protocol In example embodiments, the rank may be mapped to the device type in a look-up table provided in each device. Each device may get its rank from the look-up table and the two user devices may determine that the user device with the higher rank may be assigned as the GO and the other user device is to a client device in the ad-hoc group established by the GO user device. In example embodiments, during the exchange of device type by the two user devices, an indication of one or more other parameters (e.g., battery life remaining, processing power available, etc.) may be exchanged.

In the case where the rank of the two user devices are equal, it may be determined if both of the user devices are mobile communications devices. In example embodiments, this may be determined based at least in part on the rank associated with each of the user devices. In other words, mobile communications devices or other intelligent devices (e.g., smartphones, laptop computers, tablet computers, etc.) may be accorded a range of rank values that may be different from a range of rank values accorded to end devices (e.g., wireless keyboard, wireless mouse, wireless speakers, etc.). If the two user devices are not mobile communications devices, and are instead end devices, then it may be determined that neither user device may be the GO and the ad-hoc network may not be established, in accordance to example embodiments of the disclosure. In this case, therefore, a peer-to-peer network between two end devices are disallowed. If, on the other hand, the two end devices are mobile communications devices (e.g., intelligent user devices), then the peer-to-peer network may be established based at least in part on the one or more other parameters that were exchanged between the user devices. In example embodiments, the user device with the greatest battery time remaining may be determined to be the GO and the user device with lower batter time remaining may be determined to be the client in the group established by the GO user device. Alternatively, other parameters may be exchanged and used to determine the user device that is to be the GO, such as processing power/bandwidth, memory and/or storage available, or indeed any other suitable parameter that may impact the performance of a multi-node ad-hoc network.

In other example embodiments, two user devices that are to establish a peer-to-peer connection, during the GO establishment process, may exchange intent levels of the two user devices with each other. Exchange of the intent levels of the two user devices via GO request and GO response messages may be performed, in example embodiments, in accordance with WiFi peer-to-peer (P2P) technical specification. Upon exchanging intent levels, as part of GO negotiations via messaging, the two user devices may determine which user device is to be the GO. In example embodiments, for the case where the two user devices have dissimilar intent levels, the user device with the greater intent level may be determined to be the GO. In the case where the intent levels are the same for the two user devices, it may be determined if the intent levels indicate that both user devices are have a maximum level (e.g., 15). If both the user devices have the same maximum intent level, then the process of determining the GO may fail. On the other hand, if both user devices with the same intent level have a non-maximum intent level, then it may be determined if both user devices are end devices (e.g., user interface devices like a mouse or keyboard). If the two user devices are indeed end devices, then neither device is to be GO and a peer-to-peer connection may be disallowed between the two user devices. If, on the other hand, if the two user devices are not end devices, then the GO user device may be determined based on a tie breaker bit. In example embodiments, the tie breaker bit may be randomly and/or pseudo-randomly determined by each of the user devices. In the example embodiments, the end devices may have minimum possible intent level, and it may be determined form the perspective of both the end user devices the that neither device is to be the GO device and the P2P group is not to be established.

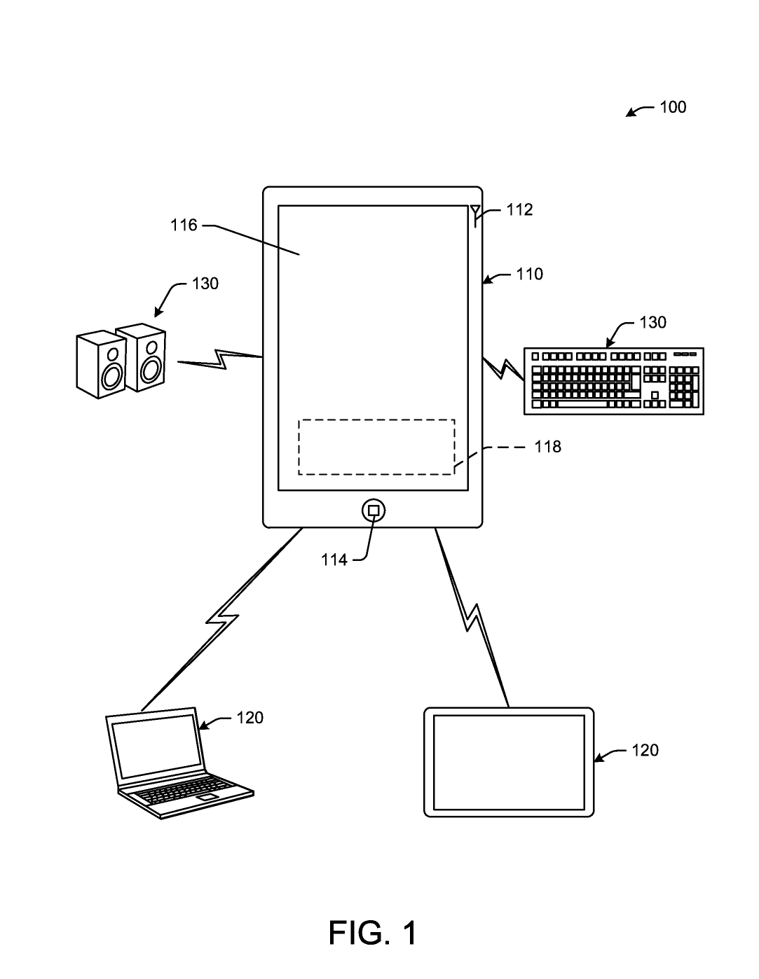

FIG. 1 is a simplified schematic diagram of an example environment 100 having a plurality of user devices 110, 120, 130 configured to communicate with one or more other user devices 110, 120, 130, in accordance with example embodiments of the disclosure. As depicted here, one of the user devices 110 may operate as a group owner (GO). This GO user device 110 may have communicative links with one or more other user devices 120 and/or one or more end user devices 130. The other user devices 120 may be mobile communications devices or other intelligent user devices. The GO user device 110 may be determined to be GO user device 110, in accordance with the systems and methods disclosed herein, from among more than one user devices 110, 120, such as from a plurality of mobile communications devices 110, 120.

The user devices 110, 120 may be any suitable communications device including, but not limited to, tablet computing devices, electronic book (ebook) readers, netbook computers, notebook computers, laptop computers, Ultrabook™ computers, personal digital assistants (PDA), smart phones, web-enabled televisions, video game consoles, set top boxes (STB), digital video recorder (DVR) systems, wearable user devices, combinations thereof, or the like. The user devices 110, 120 may be used by users of the user device 110, 120 for a variety of purposes, including performing processing tasks and/or accessing one or more networks, such as the Internet, local area networks (LANs), wide area networks (WANs), or the like. In example embodiments, the user devices 110, 120 may be configured to establish an ad-hoc network in cooperation with one or more other user devices 110, 120 and/or end devices. In certain example embodiments, the user device 110, 120 may be configured to engage in group owner (GO) negotiations to determine which user device 110, 120 is to be the group owner user device 110 of the ad-hoc network and which user device(s) 110, 120 is/are to be client user devices 120 of the established ad-hoc network. The ad-hoc network(s) established by user devices 110, 120, 130 may include WiFi direct, Bluetooth, dedicated short-range communication (DSRC), or any other packetized radio communications.

The user device(s) 110, 120 may include one or more antennas 112 for receiving and/or transmitting wireless communications signals when the ad-hoc network is being established and after the ad-hoc network has been established. The antenna(s) may be any suitable type of antenna(s) for receiving and transmitting wireless signals according to the one or more standards/protocols by which the user device 110, 120 may communicate and/or establish an ad-hoc network and determine the GO of the ad-hoc network. The user device(s) 110, 120 may be configured to determine a variety of metrics associated with one or more wireless signal(s) by which the user device 110, 120 communicate. For example the user device 110, 120 may be configured to determine metrics associated with the communicative links established, such as signal to noise ratio (SNR), bit error rate (BER), receive signal strength indicator (RSSI), or the like.

The user device(s) 110, 120 may have one or more input and/or output (I/O) user interfaces 114, 116. Although the I/O user interfaces are depicted as a button 114 and a touch-sensitive display screen 116, it will be understood that there may be any number of different I/O user interfaces 114, 116 of the user device(s) 110, 120. The I/O user interfaces 114, 116 may include, for example, micro-electromechanical system (MEMS) accelerometers, gyroscopes, display screens, push-buttons, rocker switches, keyboards, biometrics reading devices, mouse pads, mice, speakers, microphones, cameras, haptic devices, combinations thereof, or the like.

The user device(s) 110, 120 may further include one or more power sources, such as a battery 118. The battery may be charged and used to power the user device 110, 120. The battery 118 may be any suitable type of battery, including, but not limited to, wet cells, dry cells, lead-acid, lithium, lithium hydride, lithium ion, or the like, at any suitable voltage and/or output current. In certain example embodiments, the battery 118 may be rechargeable and may be recharged by one or more other power sources, such as power from a wall outlet. The user device 110, 120 may be configured to determine the amount of power remaining as stored in its battery 118. In example embodiments, the user device 110, 120 may be configured to determine the amount of battery life remaining of its battery 118 before the battery 118 has to be recharged or before the user device 110, 120 depletes all of the stored power of the battery. This may be determined based at least in part on the level of power stored in the battery 118, as well as a measure and/or estimate of a rate of depletion of the power stored in its battery 118.

The end user devices 130 may be any suitable input or output (I/O) devices to interface with a user of the user devices 110, 120. The end user devices any suitable I/O devices with which a user may interact. The end user device(s) 130 may interact with a GO user device 110 or a client user device 120 via any one or more wireless network protocols, such as WiFi direct, Bluetooth, DSRC, or any other packetized radio communications. The end user device(s) 130 may be communicatively connected to an ad-hoc network as established by one or more of the user device(s) 110, 120. The end user device(s) 130 may be configured to transmit and/or receive radio frequency wireless signals to/from one or more of the GO user device 110 and/or client user device(s) 120. Each of the end user device(s) 130 may be configured to communicate with a corresponding user device 110, 120 to transmit and/or receive signal(s) corresponding to an input from and/or output to a user in relative proximity to the end user device. The end user device(s) may include any suitable I/O device including, but not limited to, speakers, microphones, displays, keyboards, mice, joysticks, sketch pads, wearable sensor devices, cameras, or the like.

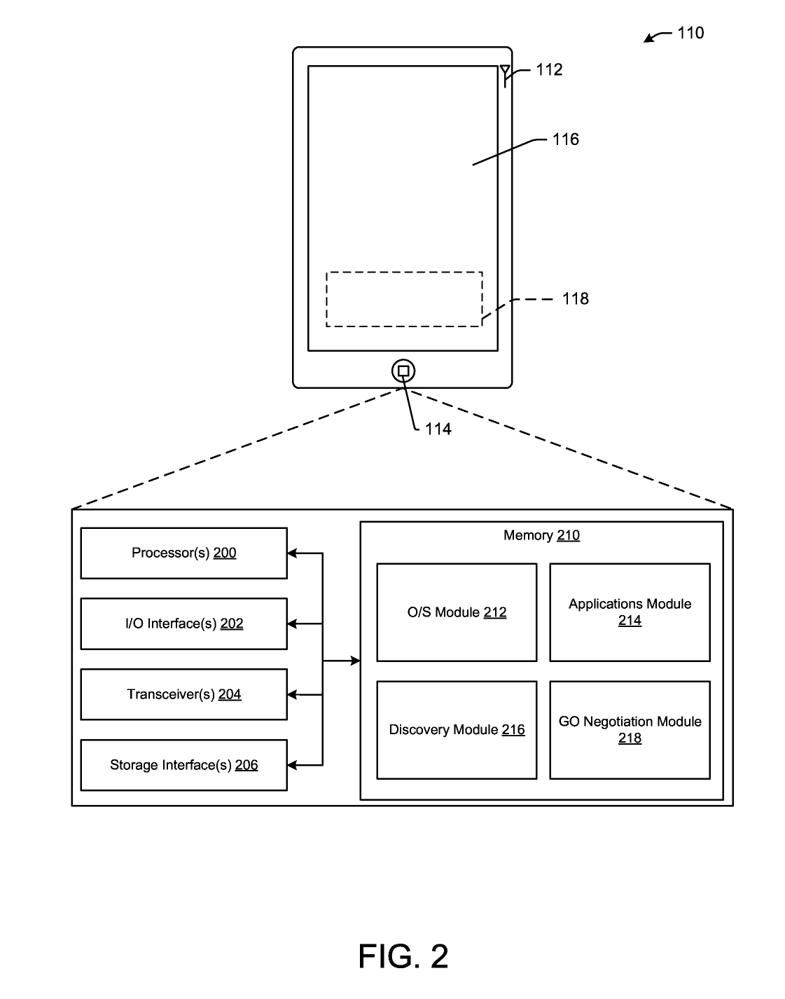

FIG. 2 is a simplified block diagram illustrating an example user device 110 for forming a peer-to-peer network, in accordance with example embodiments of the disclosure. As discussed above, the GO user device 110 may be selected from among other user devices 120 that are to form an ad-hoc network via the process of GO negotiation, in accordance with the systems and methods described herein. As a result, the user device(s) 120 that are to be client user device(s) 120 in an ad-hoc network may be similarly configured as the GO user device 110 as described with reference to FIG. 2. In other words, which of the devices 120 that are to be the CO user device 110 and the client user device(s) 120 may not be determined until the conclusion of the GO negotiation process.

The user device 110 may include the communications antenna 112 configured for transmitting and/or receiving radio frequency signals from one or more other user devices 120, 130. The communications antenna 112 may be any suitable type of antenna corresponding to the communications protocols used by the user device 110. Some non-limiting examples of suitable communications antennas 112 include Wi-Fi antennas, IEEE 802.11 family of standards compatible antennas, Wi-Fi Direct antennas, Bluetooth antennas, directional antennas, non-directional antennas, dipole antennas, folded dipole antennas, patch antennas, multiple-input multiple-output (MIMO) antennas, phased-array antennas, or the like.

The user device 110 may further include one or more processors(s) 200, one or more input/output (I/O) interfaces 202, one or more transceivers 204, one or more storage interfaces 206, and one or more memories 210.

The processor(s) 200 of the user device 110 may be implemented as appropriate in hardware, software, firmware, or combinations thereof. Software or firmware implementations of the processor(s) 200 may include computer-executable or machine-executable instructions written in any suitable programming language to perform the various functions described. Hardware implementations of the processor(s) 200 may be configured to execute computer-executable or machine-executable instructions to perform the various functions described. The one or more processor(s) 200 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The user device 110 may also include a chipset (not shown) for controlling communications between one or more processor(s) 200 and one or more of the other components of the user device 110. The processor(s) 200 may also include one or more application specific integrated circuits (ASICs) or application specific standard products (ASSPs) for handling specific data processing functions or tasks. In certain example embodiments, the user device 110 may be based on an Intel® Architecture system and the one or more processor(s) 200 and chipset may be from a family of Intel® processors and chipsets, such as the Intel® Atom® processor family.

The one or more I/O interfaces 204 may enable the use of one or more I/O user interface(s) 114, 116. The I/O interfaces 204 may be configured to receive and/or provide signals to/from the processor(s) 200 from I/O user interface(s). These signals may be related to user input and output to users that interact with the user device 110. The I/O interfaces 204 may receive and/or provide signals to any variety of I/O user interface(s) including, but not limited to, accelerometers, gyroscopes, display screens, push-buttons, rocker switches, keyboards, biometrics reading devices, mouse pads, mice, speakers, microphones, cameras, haptic devices, combinations thereof, or the like.

The communications antenna 112 may be communicatively coupled to the transceiver(s) 204 to transmit and/or receive signals, such as wireless communications signals to and/or from other user devices 120, 130. The transmit/receive (transceiver) or radio component 204 may include any suitable radio and/or transceiver for transmitting and/or receiving radio frequency (RF) signals in the bandwidth and/or channels corresponding to the communications protocols utilized by the user device 110 to communicate with other user devices 120, 130. The transceiver(s) 204 may include hardware and/or software to modulate and/or demodulate communications signals according to pre-established transmission protocols. The transceiver(s) 204 may further have hardware and/or software instructions to communicate via one or more Wi-Fi and/or Wi-Fi Direct protocols, as standardized by the Institute of Electrical and Electronics Engineers (IEEE) 802.11 standards. In certain example embodiments, the transceiver(s) 204, in cooperation with the communications antennas 112, may be configured to communicate via 2.4 GHz channels (e.g. 802.11b, 802.11g, 802.11n), 5 GHz channels (e.g. 802.11n, 802.11ac), or 60 GHz channels (e.g. 802.11ad). In alternative example embodiments, non-Wi-Fi protocols may be used for communications between user device 110 and other user device(s) 120, 130, such as Bluetooth, dedicated short-range communication (DSRC), or other packetized radio communications. The transceiver(s) 204 may include any known receiver and baseband suitable for communicating via the communications protocols of the user device 110. The transceiver(s) 204 may further include a low noise amplifier (LNA), additional signal amplifiers, an analog-to-digital (A/D) converter, one or more buffers, and digital baseband.

The one or more storage interface(s) 206 may enable the use of the memory 210 and/or other memory/storage components, such as external databases. The storage interface(s) 206 may be configured to receive data from the processor(s) 200 to store onto the memory 210 or other storage device or provide data from the memory 210 or other storage device to the processor(s) 200.

The memory 210 may include one or more volatile and/or non-volatile memory/storage devices including, but not limited to, magnetic storage devices, read only memory (ROM), random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof.

The memory 210 may store program instructions that are loadable and executable on the processor(s) 200, as well as data generated or received during the execution of these programs. Turning to the contents of the memory 210 in more detail, the memory 210 may include one or more operating systems (O/S) 212, an applications module 214, a discovery module 216, and/or a GO Negotiation module 2218. Each of the modules and/or software may provide functionality for the wireless network devices 130, when executed by the processors 200. The modules and/or the software may or may not correspond to physical locations and/or addresses in memory 210. In other words, the contents of each of the modules 212, 214,216, 218, may not be segregated from each other and may, in fact be stored in at least partially interleaved positions on the memory 210.

The O/S module 212 may have one or more operating systems stored thereon. The processor(s) 200 may be configured to access and execute one or more operating systems stored in the (O/S) module 212 to operate the system functions of the electronic device. System functions, as managed by the operating system may include memory management, processor resource management, driver management, application software management, system configuration, and the like. The operating system may be any variety of suitable operating systems including, but not limited to, Google® Android®, Microsoft® Windows®, Microsoft® Windows® Server®, Linux, Apple® OS-X®, or the like.

The application(s) module 214 may contain instructions and/or applications thereon that may be executed by the processor(s) 200 to provide one or more functionality associated with the user device 110. These instructions and/or applications may, in certain aspects, interact with the (O/S) module 212 and/or other modules of the user device 110. The applications module 214 may have instructions, software, and/or code stored thereon that may be launched and/or executed by the processor(s) 200 to execute one or more applications and functionality associated therewith. These applications may include, but are not limited to, functionality such as web browsing, business, communications, graphics, word processing, publishing, spreadsheets, databases, gaming, education, entertainment, media, project planning, engineering, drawing, or combinations thereof. In some example embodiments, the processor(s) 200, by executing instructions stored in the application(s) module 214, may be configured to establish an ad-hoc network with another user device 120, 130. In further example embodiments, the processor(s) 200 may be configured to determine a GO at the time of establishing an ad-hoc network.

The discovery module 216 may have instructions stored therein that, when executed by the processor(s) 200, enables the user device 110 to perform a variety of processes associated with discovering other user device(s) 120, 130 in its proximity and/or advertising its own presence to other user device(s) 120, 130. In example embodiments, the processor(s) 200 may be configured to transmit a beacon, such as by wirelessly broadcasting the beacon via the transceiver 204 and the antenna 112. This beacon may announce to other user device(s) 120, 130 in relative proximity of the user device 110 that the user device 110 is present within radio range. The beacon along with probe frames, in further example embodiments, may further indicate that the user device 110 from which the beacon originated is available for establishing communicative links. It will be appreciated that the establishment of one or more direct communicative links between the user device 110 and one or more other user devices 120, 130 may result in the establishment of an ad-hoc network. Therefore, in example embodiments, the user device 110 may be configured to advertise its presence via the beacon and/or any other suitable message generated and wirelessly transmitted by the user device 110.

In some example embodiments, the beacon generated and transmitted by the user device may adhere to protocols established for Wi-Fi Peer-to-Peer (P2P) Technical Specification. In other example embodiments, the beacons generated and transmitted by the user device 110 and the processor(s) 200 thereon may be a variation on the standards established for Wi-Fi P2P Technical Specification. For example, one or more information elements may be added or removed compared to standard protocols associated with Wi-Fi P2P Technical Specification. In example embodiments, the beacon may include any suitable information elements, such as in data fields within packets of data carried by the beacon, such as a user device identifier, a user device type, a user device capability, or the like. In some cases, the beacon may be referred to as a probe response and may be generated and transmitted responsive to receiving a probe request by the user device 110, such as from the user device 120, 130 with which an ad-hoc network is to be formed. In some cases, the beacon may be transmitted on a variety of channels until an appropriate channel is found for communicating between the user device 110 and the user device 120, 130 with which a communicative connection is to be established. In some example embodiments, protocols other than Wi-Fi P2P Technical Specification, such as Bluetooth, may be used for the purposes of establishing a network and, therefore, for the discovery process.

In some example embodiments, the processor(s) 200, by executing instructions stored in the discovery module 216, may be configured to transmit one or more probe requests or other suitable message to solicit a probe response or beacon signal from a user device 120, 130 with which an ad-hoc network is to be established. The user device 110 may also be configured to select from multiple channels by which to transmit the probe request(s) and then to listen for the beacon signal from the other user device 120, 130. In this way, by transmitting and receiving the probe request and the probe response between the two user devices 110, 120, 130 (e.g., in a process of scan, search, and listen) may result in successful completion of a discovery phase where the user device 110 and the processor(s) 200 thereon are configured to identify another user device 120, 130 with which to establish a communicative connection.

The GO negotiation module 218 may have instructions stored therein that, when executed by the processor(s) 200, enables the user device 110 to perform a variety of processes associated with GO negotiation with the other user device 120, 130 discovered during the discovery phase prior to the GO negotiation phase, performed by the processor(s) 200 by executing instructions stored in the discovery module 216. In example embodiments, the processor(s) 200 may be configured to transmit a GO negotiation request, such as by wirelessly broadcasting the GO negotiation request via the transceiver 204 and the antenna 112. The GO negotiation request may provide one or more information about the user device 110. In example embodiments, the GO negotiation request may carry information, such as the intent score of the user device 110. The intent score may be a number that ranges from 0 to 15 in some example embodiments and a relatively higher intent score may correspond to relatively higher probability of being deemed GO during the GO negotiation process. In example embodiments, the intent score may be pre-set for a particular user device 110, 120, 130. In other example embodiments, the intent score may be configurable for a user device 110, 120, 130, such as by user settings and/or selection. In some example embodiments, the GO negotiation request may substantially adhere to the Wi-Fi P2P Technical Specification standards. In these example embodiments, the GO negotiation request may carry the information elements that are generally provided when setting up a peer-to-peer connection via Wi-Fi P2P Technical Specification between two user devices 110, 120, including, for example, the intent score of the user device 110.

In other example embodiments, the GO negotiation request may be a variation of the Wi-Fi Peer-to-Peer (P2P) Technical Specification standard. In these cases, for example, additional or fewer information elements may be carried by the GO negotiation request. In example embodiments, where the GO negotiation request may differ from the Wi-Fi Peer-to-Peer (P2P) Technical Specification standards and protocols, additional information elements may be provided via the GO negotiation request. These additional information elements may include a device type indicator and/or an indicator representing one or more parameters of the user device 110. The device type indicator may map to a device rank. In other words, different devices may have corresponding device rank that may be indicative of a particular user device's likelihood of being a GO device. The device rank may, in example embodiments, be different from the intent value associated with Wi-Fi P2P Technical Specification protocols and standards. The device rank may correspond to the likelihood that a particular user device 120, 130 is to be deemed a GO user device 110. For example, a user device 110 with a higher rank than another user device 120, 130 may be determined to be the GO user device 110. In example embodiments, the rank may correspond to device type. For example, a mobile user device 120 may have a greater rank than an end user device 130. As another non-limiting example, a laptop computer may have a greater device rank than a tablet computing device, which in turn may have a greater device rank than a smartphone user device. In some example embodiments, an end user device 130 may have a rank of 0 and that rank of 0 may be determined to disallow the end user device 130 to be a GO user device 110. The device type may be defined by a Wi-Fi Alliance (WFA) document and may be communicated as one or more information elements. The device rank may be determined based at least in part on the device type. The processor(s) 200 may be configured to identify the device rank of user device 110 in which the processor(s) 200 are disposed based at least in part on an identification of its own device type (e.g., the device type of user device 110). The processor(s) 200 may be configured to determine the device rank based at least in part on accessing a look-up table that maps the device types of various device(s) to a corresponding respective device rank. The processor(s) 200 may further be configured to receive the device type with another user device 120, 130 with which it may be performing GO negotiations and the processors may be configured to identify the device rank of the other user device 120, 130 based at least in part on the received indication of the other user device's device type. The processors(s) 200 may be configured to access the look-up table to determine the other user device's device rank. The processor(s) 200 may further be configured to compare its own device rank 110 to the device rank of the other user device 120, 130 to identify which device rank is greater, and therefore which device is to be the GO user device 110.

The indicator representing one or more parameters may indicate any suitable parameter that may be utilized in determining which user device 120, 130 is to be deemed a GO user device 110. In example embodiments, an estimate of remaining battery life of the battery 118 of the user device 110 may be provided as information that may be utilized to determine which user device 120, 130 is to be deemed a GO user device 110. The processor(s) 200 may be configured to identify the battery life by identifying the remaining power stored in the battery 118 and by making an estimate of a rate of battery depletion. In some cases, the processor(s) 200 may consider the applications and functions being utilized on the user device 110 to estimate the power usage from the battery 118. For example, the processor(s) 200 may determine the level of power being consumed by executing certain applications that may be stored in the application module 214. Additionally, the processor(s) 200 may identify that certain components of the user device 110 may be operating to provide functionality being used by a user of the user device 110 and the power depletion associated with that functionality and associated components of the user device 110. For example, the processor(s) 200 may identify that a particular application is making use of a global positioning system (GPS) of the user device 110 and may estimate the power dissipation associated with the operation of that component of the user device 110. Another parameter of the user device 110 that the user device 110 may be configured to transmit via the GO negotiation request may include an estimate of an available processing bandwidth of the user device 110, such as the processing bandwidth of the processor(s) 200. Yet another parameter that the user device 110 may be configured to transmit via the GO negotiation request may be an indication of the antenna 112 and/or transceiver 204 capabilities of the user device 110. If the user device 110 has antennas 112 and/or a transceiver 204 that allow the user device 110 to have a greater radio and/or communicative range than another device, then that user device 110 may be more suitable for being a GO than the other device with which an ad-hoc network is to be formed.

In other example embodiments, a standard other than Wi-Fi P2P Technical Specification may be used for the establishment of the ad-hoc network. As a result, in these embodiments, the processor(s) 200 of the user device 110 may be configured to engage in a GO negotiation in accordance with one or more other standards, such as Bluetooth. In these embodiments, with standards other than Wi-Fi P2P Technical Specification, an intent score or similar metric may still be exchanged between the user device 110 and other user device(s) 120, 130 with which an ad-hoc network is to be established. In these non-Wi-Fi P2P Technical Specification-based ad hoc networks, similar information may be exchanged using messages similar to GO negotiation request. These example information elements may include an intent score or indication of device type (e.g., from which a device rank may be determined), an indication of power remaining or battery life of the user device 110, an indication of the processing bandwidth of the user device 110, and/or an indication of the communications range of the user device 110.

In example embodiments, the GO negotiation request may solicit a GO negotiation response. The GO negotiation response may be received from another user device 120, 130 with which the user device 110 and the processor(s) 200 thereon are to form an ad-hoc network. The user device 110 may be configured to receive the GO negotiation response from the other user device 120, 130 and may be configured to identify one or more information elements associated with the other user device 120, 130 therefrom. In example embodiments, the user device 110 and the processor(s) 200 thereon, by executing instructions stored in the GO negotiation module 218 may be configured to identify a intent value or device type, a battery life remaining, processing bandwidth, communications range, and/or any other suitable information associated with the user device 120, 130 from which the GO negotiation request is received.

In some example embodiments, the processor(s) 200, by executing instructions stored in the GO negotiation module 218, may enable the user device 110 to receive a GO negotiation request and extract information elements of another user device 120, 130 therefrom. The user device 110 may further be configured to provide a GO negotiation response responsive to the GO negotiation request received. The GO negotiation response, as described above may wirelessly carry one or more information elements, such as an intent score, an indication of device type associated with the user device 110, an indication of battery life remaining of the battery 118 of the user device 110, an indication of processing power of the processor(s) 200, or an indication of the range of the transceiver 204 and the antenna 112 of the user device 110.

The user device 110 and the processor(s) 200 thereon, by executing the instructions stored in the GO negotiation module 218, may be configured to identify one or more information elements with the user device 110, as well as information elements associated with another user device 120, 130. The user device 110 may be configured to identify the information elements of the other user device 120, 130 by the systems and mechanisms described above, including receiving the information elements via either a GO negotiation request message or a GO negotiation response message received from the other user device 120, 130. Upon identifying the information elements of the user device 110 and the other user device 120, 130, the processor(s) 200 may be configured to identify which user device is to be the GO user device 110 and which user device is to be a client user device 120 or end user device 130.

In example embodiments, the processor(s) 200 may be configured to identify a rank of the user device 110 and the other user device 120, 130. The rank may be determined by accessing a look-up table that maps device type with the device rank. Therefore, upon identifying its own device type, the user device 110 and the processor(s) 200 thereon may be configured to identify its own device rank by accessing the look-up table. The look-up table, in example embodiments, may be stored in the memory/storage 210 or any suitable external storage device. Still further, the processor(s) 200, upon receiving an indication of the user device type of the other user device 120, 130, may be configured to use the look-up table to identify the device type of the other user device 120, 130. In these embodiments, if the rank of the user device 110 and the other user device 120, 130 are dissimilar, then the processor(s) 200 may be configured to determine that the user device 110, 120, 130 with the greater rank score is to be the GO user device 110. In the same or different embodiments, if the processor(s) 200 determine that he rank of the user device 110 and the other user device 120, 130 is the same value and the rank values indicate that both user devices are end user devices 130, then the GO assignment may fail and the formation of an ad-hoc network may fail. In example embodiments, rank value of 0 of the user device may indicate that the user device is an end user device 130. In effect, an ad-hoc network between two end user devices 130 may be disallowed by this mechanism. If the processor(s) 200 identify that the rank of both the user devices are the same and both are mobile user devices 120, rather than an end user device (e.g., the rank of both user devices is greater than 0), then the GO may be determined based on one or more other factors. In example embodiments, the GO user device 110 may be the user device that has a greater battery life remaining among the two user devices that may be engaged in GO negotiations, as determined by an indication of battery life remaining exchanged by the user devices by way of GO negotiation request and/or GO negotiation response messages or included in probe frames. In other example embodiments, the GO user device 110 may be the user device that has a greater processing bandwidth among the two user devices that may be engaged in GO negotiations, as determined by an indication of processing bandwidth exchanged by the user devices by way of GO negotiation request and/or GO negotiation response messages or included in probe frames. In yet other example embodiments, the GO user device 110 may be the user device that has a greater radio range among the two user devices that may be engaged in GO negotiations, as determined by an indication of radio range exchanged by the user devices by way of GO negotiation request and/or GO negotiation response messages or included in the probe frames

In other example embodiments, the user device 110 may be configured to identify its own intent score and the intent score of another user device 120, 130 with which it is performing GO negotiations by exchanging GO request message(s) and/or GO response message(s). Upon identifying the intent scores of the two user devices that are to form a peer-to-peer communicative connection, the user device 110 may be configured to determine if the intent scores are the same or different. If the intent scores are different, then the user device 120 with the greater intent score may be deemed the GO user device 110. In further example embodiments, if both the intent scores are the maximum possible value of intent scores, such as 15, then the user device 110 may be configured to determine that GO assignment fails, as both user devices wish to be the GO. In the same or additional example embodiments, if the intent scores are both the same value and greater than the minimum possible value of intent scores, such as 0, then the user device 110 may be configured to use a tie breaker bit to determine which user device is to be the GO user device 110. The tie breaker bit may be a bit that is pseudo-randomly generated and may be shared between the two user devices during GO negotiation for the purposes of a tie-breaker if the intent score of the two user devices 110 are the same. In the case where the intent scores of the two user devices are equal and both equal to the minimum possible value of the intent scores, such as 0, then the user device 130 may be configured to determine that neither user device is to be GO and an ad-hoc network may not be established. In example embodiments, an intent score of 0 may be assigned to an end user device 130 and therefore, by the systems and mechanisms described herein, a peer-to-peer connection may be disallowed between two end user devices 130. It will be appreciated that when an end user device 130 (intent score=0) engages in GO negotiation with a non-end mobile user device 120 (intent score not equal to 0), the user device 120 will be deemed the GO user device 110.

In example embodiments, once a GO user device has been identified, the GO user device 110 may be configured to receive a GO negotiation confirmation from the other user device 120, 130 that confirms that the GO user device 110 is indeed the GO of a peer-to-peer communicative connection to be established. Alternatively or additionally, the processor(s) 200 of the GO user device 110 may be configured provide a GO negotiation confirmation message to the other user device 120, 130 that indicate that the GO user device 110 is the GO and the other user device 120, 130 is indeed a client user device 120, 130 in the ad-hoc network that is to be established.

It will be appreciated that there may be overlap in the functionality of the instructions stored in the operating systems (O/S) module 212, the applications module 214, the discovery module 216, and/or the GO Negotiation module 218. In fact, the functions of the aforementioned modules 212, 214, 216, 218 may interact and cooperate seamlessly under the framework of the user device 110. Indeed, each of the functions described for any of the modules 212, 214, 216, 218 may be stored in any module 212, 214, 216, 218 in accordance with certain embodiments of the disclosure. Further, in certain embodiments, there may be one single module that includes the instructions, programs, and/or applications described within the O/S module 212, the applications module 214, the discovery module 216, and/or the GO Negotiation module 218.

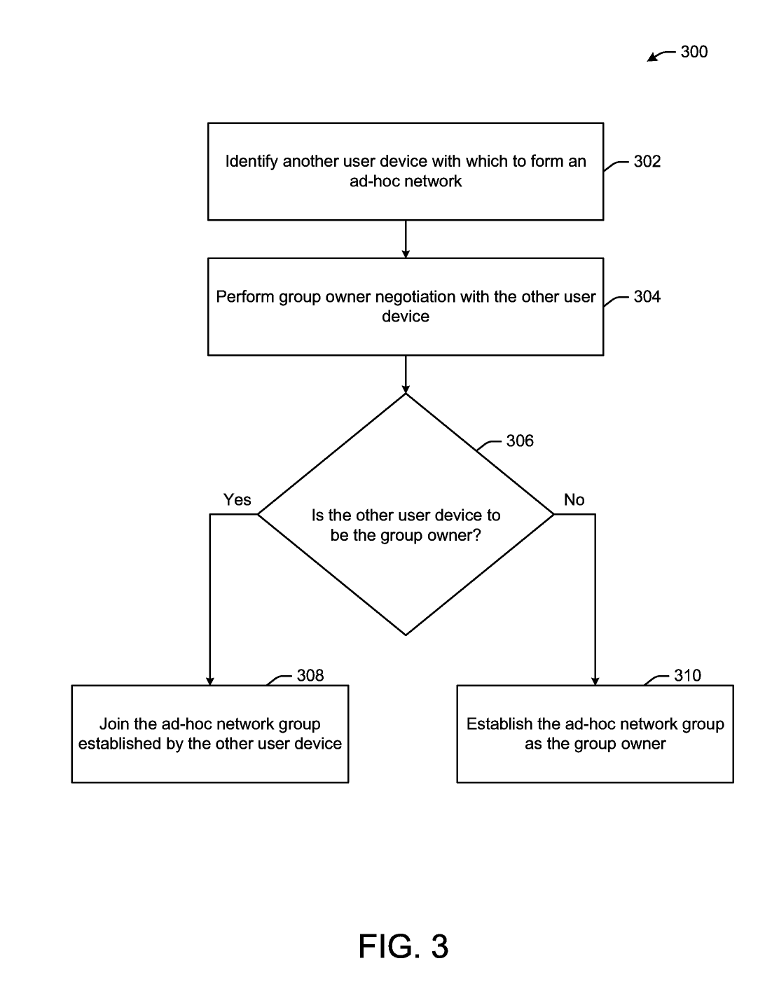

FIG. 3 is a flow diagram illustrating an example method 300 for determining a group owner user device 110 among two user devices 110, 120, 130 that are to establish an ad-hoc network, in accordance with certain example embodiments of the disclosure. This method 300 may be performed by the user device 110 and the processor(s) 200 thereon in cooperation with one or more other entities in environment 100.

At block 302, another user device with which to form an ad-hoc network may be identified. It will be appreciated that at this point, it is not known if the present user device 110, 120, 130, performing method 300 or the other user device 110, 120, 130 is to be the GO user device 110. The identification of the other user device 110, 120, 130 may entail the transmission of a beacon, such as a probe request. Furthermore, if a probe request is received, then responsive to the probe request, a probe response may be generated and transmitted to the other user device 110, 120, 130. The process of identifying the other user device may entail a series of scanning, searching, and/or listening. These processes, in example embodiments, may be performed on multiple channels to isolate a channel by which both the user device and the other user device is communicating beacon and/or probe signals. The beacon and/or probe signals may carry any variety of suitable information that may be used by the user device(s) to engage in a process of GO negotiation, such as, for example, the identify of each of the user device(s). In example embodiments, the process of identifying the other user device may be performed in accordance with pre-established Wi-Fi standards. In other example embodiments, the process of identifying the other user device may be performed as a modification to the Wi-Fi P2P Technical Specification standards or in accordance with any other suitable standard for peer-to-peer communications.

At block 304, a group owner (GO) negotiation with the other user device may be performed. GO negotiation request and/or GO negotiation response messages may be exchanged to exchange one or more information elements between the two user device 110, 120, 130 performing GO negotiations. The information elements may be any suitable information, including, but not limited to, intent scores, user device type, and/or indication(s) of one or more other parameter(s) of the user devices 110, 120, 130. The one or more indication(s) of the one or more other parameter(s) may include, for example, an indication of battery life remaining of the battery 118 of the user devices 110, 120, 130, an indication of processing power of the processor(s) 200, and/or an indication of the range of the transceiver 204 and the antenna 112 of the user device 110, 120, 130.

At block 306, it may be determined if the other user device is to be the group owner. If the other user device 110 is to be the group owner, then at block 308 the ad-hoc network group established by the other user device 110 may be joined as client user device 120, 130. If, however, at block 306, it is determined that the other user device 120, 130 is not to be the group owner, then at block 310, the ad-hoc network group may be established as the group owner user device 110. This may entail the exchange of one or more beacons, authentication messages, association request messages, and/or association response messages. Once the ad-hoc network is established by the GO user device 110, additional user devices 120, 130 may join the group as either client devices 120 or end user devices 130.

The method 300 may be performed, in certain example embodiments, by one or more of the user devices 110, 120 and the processors 200 thereon. In some example cases, the method 300 may be performed by user device 110 with a mobile user device 120 or end user device 130. By executing method 300, the user device 110 may determine if the GO should be itself 110 or the other device 120 or 130 with which it interacts. Furthermore, if the user device 110 is determined to be the GO, then it may establish the ad-hoc network with the other user device 120, 130. As discussed above, the antenna 112 and radio 204 of the user device 110 may receive and/or transmit the wireless signal(s) discussed with reference to FIG. 3 from/to the user devices 120, 130 in any suitable format, including, for example, Wi-Fi P2P Technical Specification format.

It should be noted, that the method 300 may be modified in various ways in accordance with certain embodiments of the disclosure. For example, one or more operations of method 400 may be eliminated or executed out of order in other embodiments of the disclosure. Additionally, other operations may be added to method 400 in accordance with other embodiments of the disclosure.

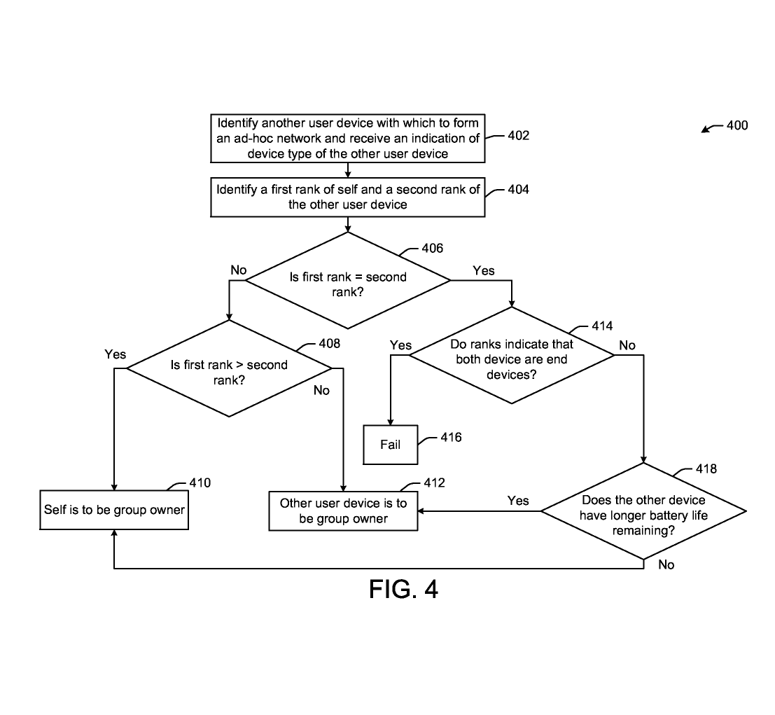

FIG. 4 is a flow diagram illustrating an example method 400 for determining a group owner of an ad-hoc network based at least in part on a rank score of each of the user devices 110, 120, 130 along with one or more other parameters associated with each of the user devices, in accordance with certain example embodiments of the disclosure. This method 400 may be performed by a user device 110, 120, 130 and the processor(s) 200 thereon to determine if it is the GO user device 110 or a client user device 120, 130.

At block 402, another user device with which to form an ad-hoc network may be identified and an indication of the other device's device type may be received. This process may be substantially similar to block 302 of method 300 or FIG. 3, and in the interest of brevity, will not be repeated here. At block 404, a first rank corresponding to itself and a second rank corresponding to the other user device may be identified. The first rank may be ascertained by the processor(s) 200 from information stored about the user device 110, 120, 130, and accessible by the one or more processor(s) 200, such as from memory 210 of the user device 110, 120, 130. This information may include the device rank itself or a device type of the user device 110 from which the device rank may be determined. The second rank may be ascertained from a device type indicated in one or more message(s) such as GO negotiation request message(s) and/or GO negotiation response message(s) exchanged with the other user device 110, 120, 130. In some example embodiments, the user device rank may be separate and distinct from the intent score that is assigned to user device(s) that use Wi-Fi P2P Technical Specification. In other example embodiments, the user device rank may be similar to the intent score that is assigned to user device(s) that use Wi-Fi P2P Technical Specification.

At block 406, it may be determined if the first rank equals the second rank. If it is determined that the first rank does not equal the second rank, then at block 408, it may be determined if the first rank is greater than the second rank. If the first rank is determined to be greater than the second rank, then at block 410, it may be determined that the user device (self) is to be the GO. If, however, at block 408 it is determined that the first rank is not greater than the second rank, then the other user device may be determined to be the GO.

Back at block 406, if it was determined that the first rank is equal to the second rank, then at block 414, it may be determined if the first and second rank indicate if both user devices are end user devices. In other words, the user device 110, 120, 130 and the processor(s) 200 thereon may utilize the first rank to determine if it is an end user device 130 itself and utilize the second rank to determine if the other user device 110, 120, 130 is an end user device 130. In some example embodiments, the rank of an end user device may be set to 0 or any other suitable predetermined value to indicate an end user device 130. If it is determined at block 414 that both the user devices are indeed end user devices, then at block 416, there may be no identification of a GO user device 110 and a peer-to-peer communicative connection may not be established. As a result, a peer-to-peer communicative connection between two end user devices 130 may be disallowed. To establish a peer-to-peer connection, at this point, a user device 110, 120 that is not an end user device 130 may establish communicative connections with one or both of the other end user devices 130.

If at block 414 it is determined that the first and second ranks do not indicate that both user devices are end user devices, then at block 418, it may be determined if the other user device has a longer battery life remaining If the other user device does indeed have a longer battery life remaining, then at block 412, the other user device is to be the GO user device. On the other hand, if the other user device does not have a longer battery life remaining, then the user device (self) may be the GO of the peer-to-peer network to be established. It will be appreciated that in alternate example embodiments, parameter(s) other than battery life remaining may be used to identify a GO user device 130 from among two user device(s) 120 that have the same user device rank. As described above, other factors that may be used to identify the GO user device 110 may include an indication of processing power of the processor(s) 200 or an indication of the range of the transceiver 204 and the antenna 112 of the user device 110. In some example embodiments, more than one of the aforementioned parameters may be considered in combination to identify the GO user device 110.

It should be noted, that the method 400 may be modified in various ways in accordance with certain embodiments of the disclosure. For example, one or more operations of method 400 may be eliminated or executed out of order in other embodiments of the disclosure. Additionally, other operations may be added to method 400 in accordance with other embodiments of the disclosure.

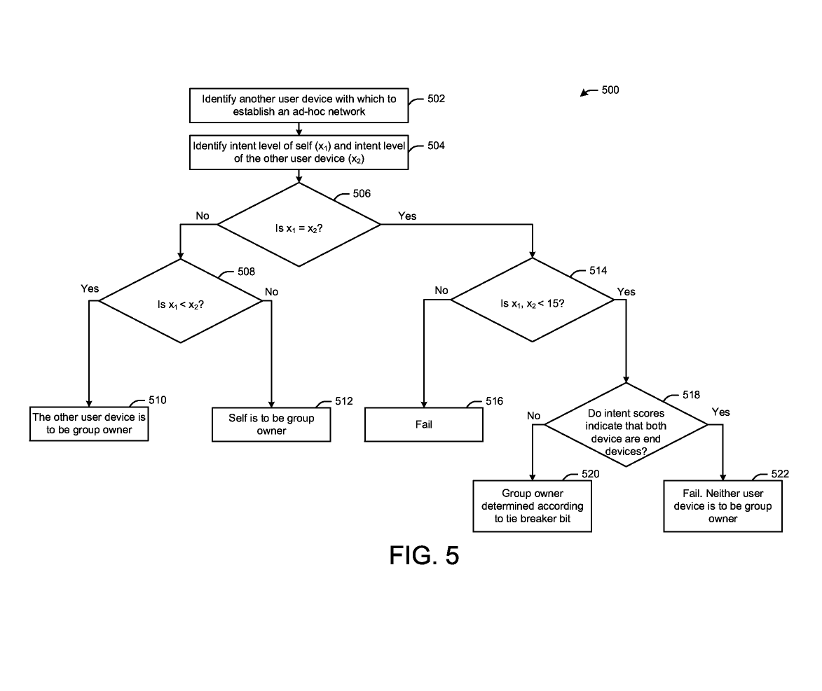

FIG. 5 is a flow diagram illustrating an example method 500 for determining a group owner of an ad-hoc network based at least in part on an intent level of two devices that are to form the ad-hoc network, in accordance with certain example embodiments of the disclosure.

At block 502, another user device with which to establish an ad-hoc network may be identified. This process may be substantially similar to block 302 of method 300 or FIG. 3, and in the interest of brevity, will not be repeated here. At block 504, an intent level of self (x₁) and intent level of the other user device (x₂) may be identified. The x₁ may be ascertained by the processor(s) 200 from information stored about the user device 110, 120, 130, and accessible by the one or more processor(s) 200, such as from memory 210 of the user device 110, 120, 130. The x₂ may be ascertained from one or more message(s) such as GO request message(s) and/or GO response message(s) exchanged with the other user device 110, 120, 130. The x₂ may be carried as an information element on one or more GO request and/or GO response message(s) from the other user device.

At block 506, it may be determined if x₁ is equal to x₂. If x₁ is not equal to x₂, then at block 508, it may be determined if x₁ is less than x₂. If x₁ is less than x₂, then at block 510, it may be determined that the other user device is to be the GO user device. On the other hand, if x₁ is not less than x₂, then at block 512, it may be determined that the user device (self) is to be the GO user device of the ad-hoc network to be established.

If at block 506 it was determined that x₁ is equal to x₂, then at block 514, it may be determined if both x₁ and x₂ are less than the maximum allowable value of the intent score (e.g., 15). If both x₁ and x₂ are set to the maximum allowed value of intent score, then at block 516, it may be determined that neither user device is to be the GO user device. In this case, a peer-to-peer communicative link between the two user devices may not be established. If, however, at block 514 it is determined that x₁ and x₂ are less than the maximum allowable value of the intent score, then at block 518, it may be determined if the intent scores indicate that both user devices are end user devices. If it is determined that both user devices are end user devices, then there may be a failure to identify a GO and a peer-to-peer communicative connection may not be established. In effect, an ad-hoc network between two end user devices 130 is, therefore, disallowed. At block 518, if it is determined that the two user devices are not end user devices, then at block 520, the GO user device may be determined according to tie breaker bit. In example embodiments, the user device with a greater tie breaker bit may be deemed the GO of the ad-hoc network to be established. In example embodiments, the tie breaker bit may be randomly or pseudo-randomly generated by each of the user devices and exchanged between the user devices by the generation, transmission, and receipt of GO negotiation request and/or GO negotiation response messages. In example embodiments, the tie breaker bit may be one of many information elements of each of the GO negotiation request and GO negotiation response messages.

It should be noted, that the method 500 may be modified in various ways in accordance with certain embodiments of the disclosure. For example, one or more operations of method 500 may be eliminated or executed out of order in other embodiments of the disclosure. Additionally, other operations may be added to method 500 in accordance with other embodiments of the disclosure.

Embodiments described herein may be implemented using hardware, software, and/or firmware, for example, to perform the methods and/or operations described herein. Certain embodiments described herein may be provided as one or more tangible machine-readable media storing machine-executable instructions that, if executed by a machine, cause the machine to perform the methods and/or operations described herein. The tangible machine-readable media may include, but is not limited to, any type of disk including floppy disks, optical disks, compact disk read-only memories (CD-ROMs), compact disk rewritable (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware. Additionally, in certain embodiments, a special-purpose computer or a particular machine may be formed in order to identify actuated input elements and process the identifications.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Example embodiments of the disclosure may include a method. The method may include identifying, by a first user device comprising one or more computer processors, a first rank of the first user device; identifying, by the first user device, a second rank of a second user device; determining, by the first user device, that the first rank and the second rank are equal; identifying, by the first user device, a first parameter associated with the first user device and a second parameter associated with the second user device; and determining, by the first user device and based at least in part on the first parameter and the second parameter, that the first user device is to be a group owner. The method may further include establishing, by the first user device, an ad-hoc network by creating a wireless communicative link with the second user device, wherein the first user device is a group owner of the ad-hoc network. The method may further include identifying that the second rank comprises receiving, from the second user device, a group owner response message indicating a device type of the second user device and determining the second rank based at least in part on the device type of the second user device. In the method, the first parameter may be an estimate of a first remaining battery time of the first user device and the second parameter may be an estimate of a second remaining battery time of the second user device. The method may further determine that the first user device is to be the group owner by identifying that the first remaining battery time is greater than the second remaining battery time.

Example embodiments of the disclosure may include one or more non-transitory computer-readable media comprising computer-executable instructions that, when executed by one or more processors, configure the one or more processors to perform a method comprising identifying a first rank of a first user device associated with the one or more processors; identifying a second rank of a second user device; determining that the first rank and the second rank are equal; identifying a first parameter associated with the first user device and a second parameter associated with the second user device; and determining, based at least in part on the first parameter and the second parameter, that the first user device is to be a group owner. The one or more non-transitory computer-readable media may be such that the method further comprises establishing an ad-hoc network by creating a wireless communicative link with the second user device, wherein the first user device is a group owner of the ad-hoc network. Furthermore, the one or more non-transitory computer-readable media may be such that wherein identifying the second rank comprises receiving a group owner response message indicating a user device type of the second user device. Further still, the one or more non-transitory computer-readable media may be such that the first parameter is an estimate of a first remaining battery time of the first user device and the second parameter is an estimate of a second remaining battery time of the second user device. Further yet, the one or more non-transitory computer-readable media may be such that determining that the first user device is to be the group owner comprises identifying that the first remaining battery time is greater than the second remaining battery time. In additional embodiments, the one or more computer-readable media may be such that the first parameter is an estimate of a first radio range of the first user device and the second parameter is an estimate of a second radio range of the second user device, and wherein determining that the first user device is to be the group owner comprises identifying that the first radio range is greater than the second radio range.

Example embodiments of the disclosure may include a user device. The user device may include an antenna communicatively coupled to a transceiver and configured to receive one or more wireless signals from another user device; and one or more processors configured to identify a first rank of the user device; identify a second rank of the other user device based at least in part on the one or more wireless signals from the other user device; determine that the first rank and the second rank are equal; identify a first parameter associated with the user device and a second parameter associated with the other user device; and determine, based at least in part on the first parameter and the second parameter, that the user device is to be a group owner. The user device may be such that the one or more processors are further configured to establish an ad-hoc network by creating a wireless communicative link with the other user device, wherein the user device is a group owner of the ad-hoc network. Furthermore, the one or more processors configured to identify the second rank comprises the one or more processors configured to receive a group owner response message indicating the second rank from the other user device. Further still, the user device may include the first parameter as an estimate of a first remaining battery time of the user device and the second parameter as an estimate of a second remaining battery time of the other user device. In yet further example embodiments, the user device may be such that the one or more processors configured to determine that the user device is to be the group owner comprises the one or more processors configured to identify that the first remaining battery time is greater than the second remaining battery time.

Example embodiments of the disclosure may include a user device. The user device may include an antenna communicatively coupled to a transceiver and configured to receive one or more wireless signals from another user device; and one or more processors configured to identify a first intent score of the user device; identify a second intent score of the other user device based at least in part on the one or more wireless signals from the other user device; determine that the first intent score and the second intent score are equal; determine, based at least in part on the first intent score and the second intent score that both the user device and the other user device are end user devices; and determine that neither the user device nor the other user device are to be a group owner. The user device may be such that the one or more processors configured to identify the second intent score comprises the one or more processors configured to receive a group owner response message indicating the second intent score from the other user device. The user device may further be such that the one or more processors configured to determine that both the user device and the other user device are end user devices comprises the one or more processors are configured to identify that the first intent score and the second intent score are both equal to zero.

Example embodiments of the disclosure may include one or more non-transitory computer readable media. The one or more non-transitory computer-readable media comprising computer-executable instructions that, when executed by one or more processors, configure the one or more processors to perform a method comprising identifying a first intent score of a user device associated with the one or more processors; identifying a second intent score of another user device; determining that the first intent score and the second intent score are equal; determining, based at least in part on the first intent score and the second intent score that both the user device and the other user device are end user devices; and determining that neither the user device nor the other user device are to be a group owner. The one or more non-transitory computer-readable may be such that identifying the second intent score comprises receiving a group owner response message indicating the second intent score from the other user device. The one or more non-transitory computer-readable media may yet further be such that determining that both the user device and the other user device are end user devices comprises identifying that the first intent score and the second intent score are both equal to zero.

The claimed invention is:

1. A method, comprising:
identifying, by a first user device comprising one or more computer processors, a first rank of the first user device;
identifying, by the first user device, a second rank of a second user device;
determining, by the first user device, that the first rank and the second rank are equal;
identifying, by the first user device, a first parameter associated with the first user device and a second parameter associated with the second user device; and
determining, by the first user device and based at least in part on the first parameter and the second parameter, that the first user device is to be a group owner.

2. The method of claim 1, further comprising:
establishing, by the first user device, an ad-hoc network by creating a wireless communicative link with the second user device, wherein the first user device is a group owner of the ad-hoc network.

3. The method of claim 1, wherein identifying the second rank comprises receiving a group owner response message indicating a device type of the second user device.

4. The method of claim 1, wherein the first parameter is an estimate of a first remaining battery time of the first user device and the second parameter is an estimate of a second remaining battery time of the second user device.

5. The method of claim 4, wherein determining that the first user device is to be the group owner comprises identifying that the first remaining battery time is greater than the second remaining battery time.

6. One or more non-transitory computer-readable media comprising computer-executable instructions that, when executed by one or more processors, configure the one or more processors to perform a method comprising:
identifying a first rank of a first user device associated with the one or more processors;
identifying a second rank of a second user device;
determining that the first rank and the second rank are equal;
identifying a first parameter associated with the first user device and a second parameter associated with the second user device; and
determining, based at least in part on the first parameter and the second parameter, that the first user device is to be a group owner.

7. The one or more non-transitory computer-readable media of claim 6, wherein the method further comprises:
establishing an ad-hoc network by creating a wireless communicative link with the second user device, wherein the first user device is a group owner of the ad-hoc network.

8. The one or more non-transitory computer-readable media of claim 6, wherein identifying the second rank comprises receiving a group owner response message indicating a device type of the second user device and determine the second rank based at least in part on the device type of the second user device by accessing a look-up table that associates various device types to corresponding respective device ranks

9. The one or more non-transitory computer-readable media of claim 6, wherein the first parameter is an estimate of a first remaining battery time of the first user device and the second parameter is an estimate of a second remaining battery time of the second user device.

10. The one or more non-transitory computer-readable media of claim 9, wherein determining that the first user device is to be the group owner comprises identifying that the first remaining battery time is greater than the second remaining battery time.

11. The one or more computer-readable media of claim 9, wherein the first parameter is an estimate of a first radio range of the first user device and the second parameter is an estimate of a second radio range of the second user device, and wherein determining that the first user device is to be the group owner comprises identifying that the first radio range is greater than the second radio range.

12. A user device, comprising:
an antenna communicatively coupled to a transceiver and configured to receive one or more wireless signals from another user device; and
one or more processors configured to:
identify a first rank of the user device;
identify a second rank of the other user device based at least in part on the one or more wireless signals from the other user device;
determine that the first rank and the second rank are equal;
identify a first parameter associated with the user device and a second parameter associated with the other user device; and
determine, based at least in part on the first parameter and the second parameter, that the user device is to be a group owner.

13. The user device of claim 12, wherein the one or more processors are further configured to establish an ad-hoc network by creating a wireless communicative link with the other user device, wherein the user device is a group owner of the ad-hoc network.

14. The user device of claim 12, wherein the one or more processors configured to identify the second rank comprises the one or more processors configured to receive a group owner response message indicating a device type of the other user device and the second rank is based at least in part on the device type of the other user device.

15. The user device of claim 12, wherein the first parameter is an estimate of a first remaining battery time of the user device and the second parameter is an estimate of a second remaining battery time of the other user device.

16. The user device of claim 15, wherein the one or more processors configured to determine that the user device is to be the group owner comprises the one or more processors configured to identify that the first remaining battery time is greater than the second remaining battery time.

17. A user device, comprising:
an antenna communicatively coupled to a transceiver and configured to receive one or more wireless signals from another user device; and
one or more processors configured to:
identify a first device type of the user device;
determine a first rank based at least in part on the first device type;
identify a second device type of another user device with which a peer-to-peer network is to be established;
identify a second rank of the other user device based at least in part on the second device type; and
determine that the user device is to be a group owner of the peer-to-peer network based at least in part on determining that the first rank is greater the second rank.

18. The user device of claim 17, wherein the one or more processors are further configured to establish the peer-to-peer network by creating a wireless communicative link with the other user device.

19. The user device of claim 17, wherein the one or more processors configured to identify a second device type of the other user device comprises the one or more processors configured to receive a group owner response message indicating the second device.

20. One or more non-transitory computer-readable media comprising computer-executable instructions that, when executed by one or more processors, configure the one or more processors to perform a method comprising:
identifying a first intent score of a user device associated with the one or more processors;
identifying a second intent score of another user device;
determining that the first intent score and the second intent score are equal;
determining, based at least in part on the first intent score and the second intent score that both the user device and the other user device are end user devices; and
determining that neither the user device nor the other user device are to be a group owner.

21. The one or more non-transitory computer-readable media of claim 21, wherein identifying the second intent score comprises receiving a group owner response message indicating the second intent score from the other user device.

22. The one or more non-transitory computer-readable media of claim 21, wherein determining that both the user device and the other user device are end user devices comprises identifying that the first intent score and the second intent score are both equal to zero.
